(19) United States
(12) Patent Application Publication
(10) Pub. No.: US 2019/0238581 A1
(43) Pub. Date: Aug. 1, 2019

(54) METHOD, APPARATUS AND SYSTEM FOR DETECTING ABNORMAL BEHAVIOR OF USER

(71) Applicant: ZhongAn Information Technology Service Co., Ltd., Shenzhen (CN)

(72) Inventors: Wenpeng SONG, Shenzhen (CN); Xiong SHEN, Shenzhen (CN)

(21) Appl. No.: 16/375,555

(22) Filed: Apr. 4, 2019

Related U.S. Application Data
(63) Continuation-in-part of application No. PCT/CN2018/094065, filed on Jul. 2, 2018.

(30) Foreign Application Priority Data
Jul. 6, 2017 (CN) 201710547742.X
Jul. 14, 2017 (CN) 201710577019.6

(51) Int. Cl. H04L 29/06; G06F 16/22; G06Q 30/00

(52) U.S. Cl. CPC H04L 63/1425; H04L 63/1416; G06Q 30/0185; G06F 16/2228

(57) ABSTRACT

The embodiments of the present invention provide a method, an apparatus and a system for detecting abnormal behavior of an user which belong to the field of computer technologies. The method includes acquiring time series data, wherein the time series data are configured to describe at least one network behavior, and determining that the user corresponding to the at least one network behavior has the abnormal behavior, when the acquired time series data are not stable. The time series data more accurately describe the network behavior of the user, therefore it is of high accuracy that determining the user has the abnormal behavior when the time series data are not stable, and the user experience is improved when surfing the internet. In addition, determining whether the user has the abnormal behavior according to the stationarity of the time series data is highly accurate and highly efficient.

### CROSS-REFERENCE TO RELATED APPLICATIONS

This application is a Continuation-In-Part application of PCT application No. PCT/CN2018/094065, filed on Jul. 2, 2018 which claims priority to CN Patent Application No. 201710547742.X, filed on Jul. 6, 2017 and CN Patent Application No. 201710577019.6, filed on Jul. 14, 2017. All of the aforementioned applications are hereby incorporated by reference in their entireties.

### TECHNICAL FIELD

Embodiments of the present invention relate to the field of computer technologies, in particular to a method, an apparatus and a system for detecting abnormal behavior of user.

### BACKGROUND

With the popularity of internet commercial activities, more and more merchants, such as shopping websites, ticketing websites, hotel reservation websites and evaluation websites, tend to further improve the internet consumption experience of an user by methods such as evaluation of snapping up and service. However, in practical applications, there are abnormal network behaviors such as malicious bills, and malicious evaluations, which may mislead consumers and affect consumers' normal internet consumption at the same time.

In the prior art, abnormal network behaviors are generally discovered through manual processes such as deletion or selection. Because of the influence of human factors, time cost and efficiency, the manual processes increases the labor cost and has low accuracy and efficiency. Thereby it is impossible to detect the abnormal network behavior of the user, which affect the normal internet consumption of the user and reduce the user experience.

### SUMMARY

In order to improve the efficiency and accuracy of detecting abnormal behavior of an user, embodiments of the present invention provide a method, an apparatus and a system for detecting the abnormal behavior of the user. The technical solution is as follows.

According to an aspect of the present invention, an embodiment of the present invention provides a method for detecting the abnormal behavior of the user, the method includes acquiring time series data, wherein the time series data are configured to describe at least one network behavior; and determining that the user corresponding to the at least one network behavior has the abnormal behavior, when the acquired time series data are not stable.

In an embodiment, the at least one network behavior includes one or more of the followings: a login request, a data transmission request and a transaction request.

In an embodiment, the acquiring time series data include: periodically acquiring the time series data, or acquiring the time series data when the time series data satisfy a preset condition.

In an embodiment, the time series data are determined according to an execution frequency of the at least one network behavior in a plurality of preset time periods, and the preset condition includes a sum of the execution frequency of the at least one network behavior corresponding to the time series data being more than a preset frequency within set time.

In an embodiment, after the determining that the user corresponding to the at least one network behavior has the abnormal behavior, the method also includes: acquiring a network address of the login apparatus of the user that has the abnormal behavior and determining whether the user corresponding to the network address and the user corresponding to a relevant network address of the network address has the abnormal behavior.

In an embodiment, the relevant network address includes a network address that belongs to a same routing apparatus with the network address that initiates a current network behavior or a network address within a preset regional range of a location of the network address that initiates the current network behavior.

In an embodiment, the method further includes performing a stationarity test on the time series data and calculating a stationarity parameter; determining that the time series data are not stable, when the stationarity parameter is more than a preset value.

In an embodiment, the time series data include at least one of a login frequency, data flow and a transaction frequency; wherein the calculating a stationarity parameter corresponding to the time series data includes: respectively calculating, a first stationarity parameter corresponding the login frequency, a second stationarity parameter corresponding to the data flow and a third stationarity parameter corresponding to the transaction frequency; and calculating a stationarity parameter according to the first stationarity parameter, the second stationarity parameter and the third stationarity parameter.

In an embodiment, the method further includes pre-processing the acquired time series data, wherein determining that the user corresponding to the at least one network behavior has the abnormal behavior when the pre-processed the time series data are not stable.

In an embodiment, the pre-processing includes anyone or any combination of the following processing methods: converting a data format of the time series data, setting a default value in the time series data, and deleting a limit value in the time series data.

In an embodiment, the setting the default value in the time series data includes one of the following methods: setting the default value which is the system default value, and setting the default value according to an adjacent data value of the default value in the time series data.

In an embodiment, the method further includes acquiring the time series data in a plurality of time periods, averaging the time series data of the plurality of time periods to acquire average time series data and determining that the user corresponding to the at least one network behavior has the abnormal behavior when the average time series data are not stable.

According to another aspect of the present invention, an embodiment of the present invention provides an apparatus for detecting the abnormal behavior of the user, the apparatus includes an acquiring module configured to acquire time series data, wherein the time series data are configured to describe at least one network behavior; and a processing module configured to determine that the user corresponding to the at least one network behavior has the abnormal behavior, when the acquired time series data are not stable.

In an embodiment, the detecting apparatus is deployed that

the at least one network behavior includes one or more of the followings: a login request, a data transmission request and a transaction request.

In an embodiment, the acquiring module is deployed that

periodically acquiring the time series data, or acquiring the time series data when the time series data satisfy a preset condition.

In an embodiment, the acquiring module is deployed that the preset condition includes a sum of the execution frequency of the time series data being more than the preset frequency within the set time.

In an embodiment, the acquiring module is deployed that acquiring the time series data corresponding to the current network behavior, when a relevant the network address of the network address initiates the current network behavior has the abnormal behavior.

In an embodiment, the acquiring module is deployed that the relevant network includes a network address that belongs to a same routing apparatus with the network address that initiates the current network behavior, or a network address within a preset regional range of a location of the network address that initiates the current network behavior.

In an embodiment, the detecting apparatus is deployed that performing a stationarity test on the time series data and calculating a stationarity parameter; wherein determining that the time series data are not stable, when the stationarity parameter is more than a preset value.

In an embodiment, the detecting apparatus is further deployed that pre-processing the acquired time series data, and determining that the user corresponding to the at least one network behavior has the abnormal behavior when the pre-processed time series data are not stable.

In an embodiment, the detecting apparatus is further deployed that the pre-processing includes anyone or any combination of the following processing methods: converting a data format of the time series data, setting a default value in the time series data, and deleting a limit value in the time series data.

In an embodiment, the detecting apparatus is deployed that the setting a default value in the time series data includes one of the following methods: setting the default value which is the system default value, and setting the default value according to the adjacent data value of the default value in the time series data.

In an embodiment, the detecting apparatus is deployed that acquiring the time series data in a plurality of time periods, averaging the time series data of the plurality of time periods to obtain average time series data and determining that the user corresponding to the at least one network behavior has the abnormal behavior when the average time series data are not stable.

According to another aspect of the present invention, an embodiment of the present invention provides an apparatus for detecting the abnormal behavior of the user, the apparatus includes: a processor; and a memory, configured to store an instruction, wherein when the instruction is executed, the processor implements the following steps: acquiring time series data, wherein the time series data are configured to describe at least one network behavior; and determining that the user corresponding to the at least one network behavior has an abnormal behavior, when the acquired time series data are not stable.

In an embodiment, the at least one network behavior comprises one or more of the following: a login request, a data transmission request and a transaction request.

In an embodiment, when implementing the step of acquiring time series data, the processor specifically implements the following steps: periodically acquiring the time series data, or acquiring the time series data when the time series data satisfy a preset condition.

In an embodiment, the preset condition comprises a sum of the execution frequency of corresponding to the time series data being more than a preset frequency within a set time.

In an embodiment, when implementing the step of acquiring time series data, the processor specifically implements the following steps: acquiring the time series data corresponding to the current network behavior, when a relevant network address of the network address initiates a current network behavior has the abnormal behavior.

In an embodiment, the relevant network comprises a network address that belongs to a same routing apparatus with the network address that initiates the current network behavior or a network address within a preset regional range of a location of the network address that initiates the current network behavior.

In an embodiment, the processor further implements the following steps: performing a stationarity test on the time series data and calculating a stationarity parameter; wherein determining that the time series data are being not stable, when the stationarity parameter is more than a preset value.

In an embodiment, the processor further implements the following steps: pre-processing the acquired time series data, wherein determining that the user corresponding to the at least one network behavior has the abnormal behavior when the pre-processed the time series data are not stable.

In an embodiment, when implementing the step of pre-processing the acquired time series data, the processor specifically implements anyone or any combination of the following steps: converting a data format of the time series data, setting a default value in the time series data and deleting a limit value in the time series data.

In an embodiment, when implementing the step of setting a default value in the time series data, the processor specifically implements one of the following steps: setting the default value as the system default value and setting the default value according to the adjacent data value of the default value in the time series data.

In an embodiment, when implementing the step of determining that the user corresponding to the at least one network behavior has an abnormal behavior, the processor specifically implements the following steps: acquiring the time series data in a plurality of time periods, averaging the time series data of the plurality of time periods to obtain average time series data and determining that the user corresponding to the at least one network behavior has the abnormal behavior when the average time series data are not stable.

According to another aspect of the present invention, an embodiment of the present invention provides a computer apparatus, the computer apparatus includes a memory, a processor, and a computer program stored on the memory and performed by the processor, wherein the processor executes the computer program to implement the method of any one of above.

According to another aspect of the present invention, an embodiment of the present invention provides a computer readable storage medium where a program is stored in, wherein the program executes the computer program to implement the method of any one of above.

According to another aspect of the present invention, an embodiment of the present invention provides a system for detecting abnormal behavior of an user. The system includes a plurality of servers and a plurality of clients. The plurality of servers communicate with the plurality of clients, wherein the client is configured to implement the at least one network behavior and generate the time series data. The server includes the detecting apparatus according to any one of above.

The embodiments of the present invention provide a method, an apparatus and a system for detecting the abnormal behavior of the user, which includes acquiring the time series data, wherein the time series data are configured to describe the at least one network behavior; and determining that the user corresponding to the at least one network behavior has the abnormal behavior, when the acquired time series data are not stable. The time series data more accurately describe the network behavior of the user, therefore it is of high accuracy and high efficiency that determining the user has the abnormal behavior when the time series data are not stable, and the user experience is improved when surfing the internet.

### BRIEF DESCRIPTION OF DRAWINGS

In order to more clearly illustrate the technical solutions in the embodiments of the present invention, the drawings used in the description of the embodiments will be briefly described below. It is obvious that the drawings in the following description are only some embodiments of the present invention. For those skilled in the art, other drawings may be obtained according to these drawings without any creative work.

FIG. 1 is a flowchart of a method for detecting abnormal behavior of an user according to an embodiment of the present invention.

FIG. 2 is a flowchart of a method for detecting abnormal behavior of the user according to an embodiment of the present invention.

FIG. 3 is a flowchart of a method for detecting abnormal behavior of the user according to an embodiment of the present invention.

FIG. 4 is a flowchart of a method for detecting abnormal behavior of the user according to an embodiment of the present invention.

FIG. 5 is a schematic diagram of time series data according to an embodiment of the present invention.

FIG. 6 is a flowchart of a method for detecting abnormal behavior of the user according to an embodiment of the present invention.

FIG. 7 is a structural diagram of an apparatus for detecting abnormal behavior of the user according to an embodiment of the present invention.

FIG. 8 is a structural diagram of an apparatus for detecting abnormal behavior of the user according to an embodiment of the present invention.

FIG. 9 is a structural diagram of an apparatus for detecting abnormal behavior of the user according to an embodiment of the present invention.

FIG. 10 is a structural diagram of an apparatus for detecting abnormal behavior of the user according to an embodiment of the present invention.

FIG. 11 is a structural diagram of a system for detecting abnormal behavior of the user according to an embodiment of the present invention.

### DETAILED DESCRIPTION

In order to more clearly illustrate the purpose, technical solution and advantages of the present invention hereinafter specific embodiments of the present invention will be further described in detail with reference to the appended drawings.

The embodiment of the present invention provides a method for detecting abnormal behavior of an user, which is mainly applied to detect the abnormal behavior of the user in a trading system or a system including trading business. The system includes but is not limited to shopping websites, ticketing websites, hotel reservation websites and evaluation websites and the like. The trading business may include business such as snapping, ordering, and evaluation. The products of the business may include network tickets, network products, and e-commerce products. In practical applications, the abnormal network behavior of the user includes but is not limited to malicious billing, malicious login and malicious snap-up behavior etc.

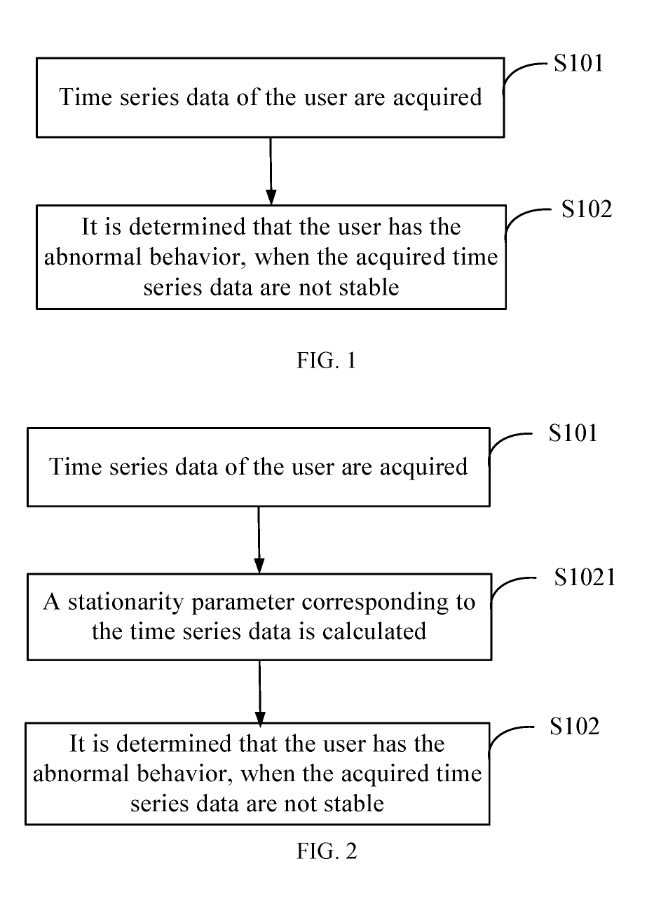

According to an aspect of the present invention, an embodiment of the present invention provides a method for detecting the abnormal behavior of the user. As is shown in FIG. 1, the method includes the following steps.

S101, time series data of the user are acquired. The time series data are configured to describe at least one network behavior of the user. For example, the time series data may be identified by an execution frequency of the at least one network behavior in a plurality of preset time periods.

S102, it is determined that the user has the abnormal behavior, when the acquired time series data are not stable.

The time series data more accurately describe the network behavior of the user, therefore it is of high accuracy and high efficiency that determining the user has the abnormal behavior when the time series data are not stable. As a result, the user's internet experience is improved.

In an embodiment, the at least one network behavior includes one or more of the followings: a login request, a data transmission request and a transaction request. It should be understood that different network behaviors may be selected in the present embodiment according to requirements of actual application scenarios, as long as the selected network behavior can accurately describe the user's operation behavior. The type of the network behavior is not limited in the present embodiment.

In an embodiment, the acquiring time series data may include periodically acquiring the time series data. The embodiment provides a method for acquiring the time series data: the time series data are periodically acquired and the acquiring period may be adjusted timely according to actual conditions. The adjusting method includes but is not limited to shortening the period when the current trading volume, tradable products and the number of online users are relatively large and increasing the period when the current trading volume, tradable products and the number of online users are relatively small.

In an embodiment, the acquiring the time series data may include acquiring the time series data when the time series data satisfy a preset condition. The embodiment provides another method for acquiring time series data: the time series data are acquired when the time series data satisfy a preset condition. The acquired time series data can accurately describe the network behavior of the user.

In a further embodiment, the preset condition may include a sum of the execution frequency of the network behavior corresponding to the time series data within a set time being more than a preset frequency. When the sum of the execution frequency of one or more network behavior within the set time is more than the preset frequency, the user corresponding to the network behavior is more likely to have the abnormal behavior. By setting the preset condition, it is possible to more specifically acquire the time series data corresponding to the abnormal network behaviors of the user with high probability.

In an embodiment, after the determining that the user corresponding to the at least one network behavior has the abnormal behavior, the method also includes acquiring a network address of a login apparatus of the user that has the abnormal behavior and determining whether the user corresponding to the network address and other network addresses of the network address have the abnormal behavior. Because the abnormal behavior may be executed by multiple persons in a certain range at the same time, for example, multiple scalpers snapping tickets up or the like behaviors. Therefore, the abnormal behavior of a plurality of users may be found in time by determining whether the users related to the network address has the abnormal behavior, and the accuracy and the efficiency are high.

In a further embodiment, a relevant network address includes a network address that belongs to the same routing apparatus with the network address that initiates the current network behavior, or a network address within a preset regional range of a location of the network address that initiates the current network behavior. Therefore, the abnormal behavior of a plurality of users may be found in time by determining whether the users related to the network address have the abnormal behavior, and the accuracy and the efficiency are high.

In an embodiment, the time series data include at least one of a login frequency, data flow and a transaction frequency. The calculating a stationarity parameter corresponding to the time series data includes respectively calculating a first stationarity parameter corresponding to the login frequency, a second stationarity parameter corresponding to the data flow and a third stationarity parameter corresponding to the transaction frequency. The stationarity parameter is calculated according to the first stationarity parameter, the second stationarity parameter and the third stationarity parameter. A plurality of stationarity parameters corresponding to the time series data are calculated and a final stationarity parameter according to the plurality of stationarity parameters is weighted average calculated. When the final stationary parameter indicates that the time series data are non-stationary time series data, the abnormal behavior is confirmed. According to the plurality of stationarity parameters, the final stationarity parameter is obtained, and various aspects can be comprehensively considered, thereby the accuracy of the judgment of the time series data stationarity is further improved.

In an embodiment, the step S102 may further include performing a stationarity test on the time series data and calculating a stationarity parameter, and determining that the user corresponding to the at least one network behavior has the abnormal behavior, when the stationarity parameter is more than a preset value.

The stationarity parameter is calculated by performing the stationarity test on the time series data. Compared with other methods, determining the user has the abnormal behavior when the stationarity parameter is more than the preset value has higher accuracy and efficiency.

In an embodiment, the stationarity test method may include any one of the following methods: unit root test, PP (Phillips & Perron) test, KPSS test, DF-GLS test, ERS test, and NP test, and the present invention does not limit the specific test method.

In an embodiment, the detection method also includes pre-processing the acquired time series data and determining that the user corresponding to the at least one network behavior has the abnormal behavior when the pre-processed time series data are not stable. The negative effects on the result of detecting the abnormal behavior of the user, brought by the data acquisition error, network error and the user's misoperation, can be avoided by pre-processing the acquired time series data; thereby the accuracy of detecting the abnormal behavior of the user is improved.

In a further embodiment, the pre-processing includes anyone or any combination of the following processing methods: converting a data format of the time series data; setting a default value in the time series data and deleting a limiting value in the time series data.

It should be understood that different methods of pre-processing may be selected in the present embodiment according to the requirements of the actual application scenario, as long as the acquired time series data can be processed to improve the accuracy of the detection, and the present embodiment does not limit the method of pre-processing.

In a further embodiment, the setting the default value in the time series data includes one of the following methods: setting the default value which is the system default value and setting the default value according to the adjacent data value of the default value in the time series data.

It should be understood that different methods of setting the default value may be selected in the present embodiment according to the requirements of the actual application scenario, as long as the method of setting the default value of the acquired time series data can improve the accuracy of detection, and the present embodiment does not limit the method of setting the default value.

In an embodiment, the method may further include acquiring the time series data in a plurality of time periods, averaging the time series data of the plurality of time periods to obtain an average time series data, and determining that the user corresponding to the at least one network behavior has the abnormal behavior when the average time series data are not stable. The stability of the average time series data is comprehensively determined by averaging the time series data in the plurality of time periods and the accuracy of detection of the abnormal behavior of the user is improved. The averaging method includes but is not limited to one of the following methods: direct averaging or weighted averaging.

On the basis of the above embodiments, another embodiment of the present invention provides a method for detecting the abnormal behavior of the user. As shown in FIG. 2, the method includes the following steps.

S101, time series data of the user are acquired. The time series data are configured to describe the network behavior.

Specifically, the step of acquiring the time series data of the user is implemented by any one of the following operations: the time series data are periodically acquired, or the time series data are acquired when the time series data satisfy a preset condition.

Before Step 1021, the following step may also be performed:

the time series data are pre-processed to generate the pre-processed time series data.

S1021, a stationarity parameter corresponding to the time series data is calculated.

Specifically, a unit root test is performed on the pre-processed time series data, and the stationarity parameter included in the test result is acquired.

Optionally, the time series data include at least one of a login frequency, data flow and a transaction frequency. The calculating the stationarity parameter corresponding to the time series data includes calculating respectively the first stationarity parameter corresponding the login frequency, the second stationarity parameter corresponding to the data flow, and the third stationarity parameter corresponding to the transaction frequency; and calculating the stationarity parameter according to the first stationarity parameter, the second stationarity parameter, and the third stationarity parameter.

S102, it is determined that the user has no abnormal behavior when the stationarity parameter indicates that the time series data are stable, otherwise, it is determined that the user has the abnormal behavior.

Optionally, after the determining that the user corresponding to the at least one network behavior has the abnormal behavior, the method also includes acquiring a network address of the login apparatus of the user that has the abnormal behavior, and determining whether the user corresponding to the network address and the user corresponding to a relevant network address of the network address have the abnormal behavior.

Optionally, the method also includes acquiring the time series data in a plurality of time periods and calculating a plurality of stationarity parameters corresponding to the plurality of time periods, and calculating a final stationarity parameter according to the stationarity parameters. If the final stationarity parameter indicates that the time series data are stable, the user is confirmed to have no abnormal behavior; otherwise, the user is confirmed to have the abnormal behavior.

The embodiment of the present invention provides a method for detecting the abnormal behavior of the user. Because the time series data more accurately describe a network behavior of the user, it is of high accuracy that determining the user has the abnormal behavior when the time series data are not stable, and the user experience is improved when surfing the internet. In addition, compared with other methods, determining whether the user has the abnormal behavior by the stationarity of the time series data is highly accurate and highly efficient.

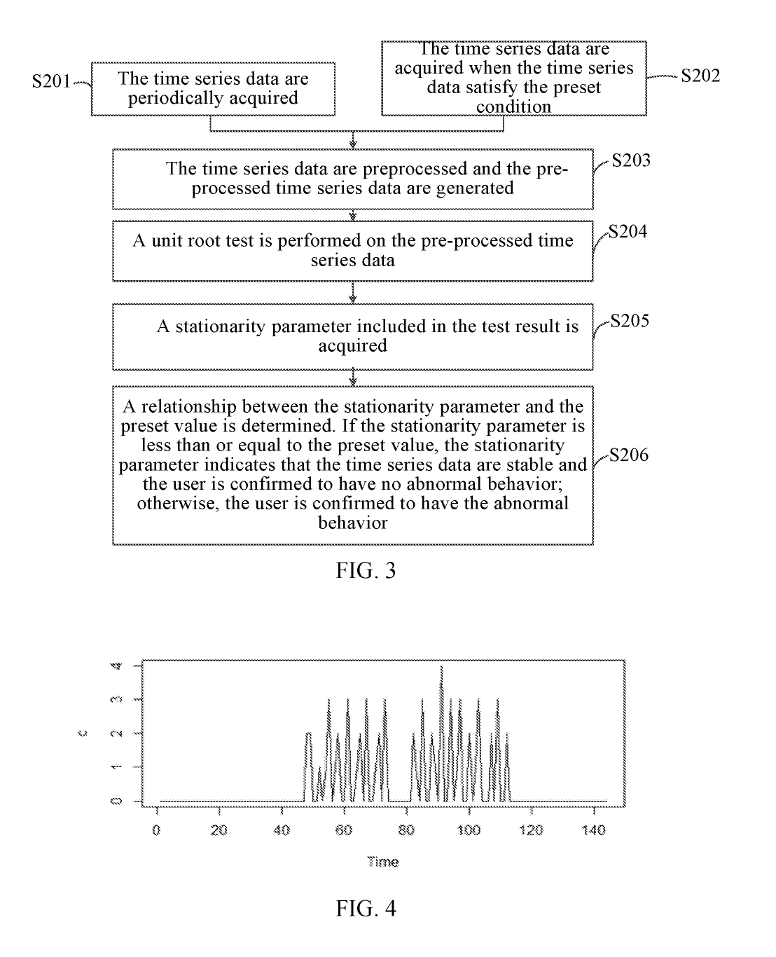

Another embodiment of the present invention provides a method for detecting abnormal behavior of the user. In the embodiment of the present invention, the time series data include login frequency. As shown in FIG. 3, the method includes the following steps.

S201, the time series data are periodically acquired.

Specifically, the time series data are configured to describe the network behavior of the user. In the embodiment of the present invention, the time series data may be the login frequency of the user.

The process of the step S201 may include: recording login frequency of the user when the user is logging in and acquiring all the login frequency of the user and each login time within a time interval when the time interval between the record start time and the current time satisfied a preset period.

The preset period may be timely adjusted according to actual conditions. The adjusting method includes but is not limited to shortening the period when the current trading volume, tradable products and the number of the online user are relatively large and increasing the preset period when the current trading volume, tradable products and the number of online user are relatively small.

It may be realized that real-time monitoring of the network behavior of the user by periodically acquiring time series data. Thereby, the negative effects on other users' network behavior brought by the abnormal behavior of malicious users, especially the negative effects of network behaviors such as network transactions, can be avoided and the user experience is improved. In addition, by timely adjusting the preset period according to the actual situation, the abnormal behavior of the user can be discovered in time when the current transaction volume, the tradable product and the number of the online user are large, thereby the efficiency of the abnormal behavior detection and the user experience are improved. When the current transaction volume, the tradable product and the number of the online user are small, the data processing load of the system is reduced.

After Step S201, Step S203 is performed.

S202, the time series data are acquired when the time series data satisfy the preset condition and after Step S202, Step S203 is performed.

Specifically, the time series data are the same as the time series data described in Step S201, and details are not repeated herein.

The preset condition satisfied by the time series data in the step S202 may include recording login frequency of the user, and obtaining all the login frequency and each login time of the user when the user is logging in between the first login and the current time when the cumulative number of login frequency of the user is more than or equal to the preset value.

The above-mentioned preset condition is only exemplary. In practical applications, other preset conditions may also be set, and the specific preset condition is not limited in the embodiment of the present invention.

Since an user may be confirmed as having the abnormal behavior when the user's login frequency is too large in one day, compared with acquiring the real-time series data of all users, acquiring the time series data when the time series data satisfy the preset condition reduces the burden of the data processing and improves efficiency of the abnormal behavior detection, and the user experience is further improved.

It should be noted that any one of the step S201 and the step S202 is a process for acquiring the time series data of the user. In the applications, any one of the step S201 and the step S202 may be performed. In addition, in the practical application, Step S201 or Step S202 may be selected according to a specific application scenario which includes but is not limited to that when the abnormal behavior of the user in the current system is large, or when the current system may have the abnormal behaviors such as user malicious bills due to business reasons (such as the existence of transactions and snapping services), selecting Step S201 to implement real-time monitoring of the online user in order to ensure the user experience of other users with normal trading needs, and when the abnormal behavior of the user in the current system is small or the abnormal behavior of the user such the user malicious bills is less due to business reasons (when the business such as snapping up is small) and the customer group (such as a specific group of customers), or the needed efficiency of the abnormal behavior discovery and processing are high, selecting Step S202 to implement in order to reduce the data processing burden and improve the efficiency of detecting the abnormal behavior of the user.

Before the step S102, the following step may also be performed.

S203: the time series data are pre-processed and the pre-processed time series data are generated.

Specifically, Step S203 is implemented by at least one of the following operations.

The maximum value or the minimum value and the like are deleted from the time series data and the pre-processed time series data are generated. The above process may be performed by the processing rule of deleting maximum and minimum values, and the present embodiment does not limit the specific implementation method.

Or the default value is set as the system default value and the pre-processed time series data are generated; or the default value is set according to the value of a last time value and a value of the next time, and the present embodiment does not limit the specific setting method.

Or a data format of the time series data is converted and the pre-processed time series data are generated. The pre-processed time-series data include the system-readable login frequency and the login time and the present embodiment does not limit the specific converting method.

The negative effects on the result of detecting the abnormal behavior of the user, brought by the limit value of acquisition error, network error and the user's misoperation can be avoided by deleting the maximum value or the minimum value; thereby, the accuracy of detecting the abnormal behavior of the user is improved. In addition, the negative effects on the result of detecting the abnormal behavior of the user, brought by data loss, can be avoided by setting the default value as the system default value; and, the accuracy of detection the abnormal behavior of the user is improved. In addition, abnormal detecting or undetecting of the user's abnormal behavior, because of the format incompatibility or other reasons, can be avoided by converting the data format of the time series data, thereby, the accuracy and efficiency of detection the abnormal behavior of the user are improved.

It should be noted that Step S203 is an optional step. In actual application, after Step S201 or Step S202, Step S204 may be directly performed, and Step S203 is not necessarily performed.

S204, a unit root test is performed on the pre-processed time series data.

Specifically, the step may be setting the time interval, and the setting process may be set according to the current volume of transactions, tradable products and the number of online users. For example, when the current transaction volume, the tradable product and the number of online users are large, the time interval is set to be shorter, and when the current transaction volume, tradable products and the number of online users are small, the time interval is set to be longer.

The unit root test is performed on the pre-processed time series data according to the time interval and the unit root test may be implemented by functions, such as ADF. test function.

Optionally, in addition to the unit root test on the pre-processed time series data, PP (Phillips & Perron) test, KPSS test, DF-GLS test, ERS test, NP test and the like may be performed on the pre-processed time series data. The present embodiment does not limit the method of detecting.

S205, a stationarity parameter included in the test result is acquired.

Specifically, the P value obtained after the unit root test is the stationarity parameter, and the stationarity parameter is used for indicating whether the time series data are stationary time series data.

The present embodiment does not limit the method of acquiring the test result.

It should be noted that Step S204 to Step S205 are the process of calculating the stationary parameter corresponding to the time series data. In addition to the method described in the above steps, the process may be implemented in other ways, and the present embodiment does not limit the specific method.

Because the time series data more accurately describe a network behavior of the user, determining whether the user has the abnormal behavior through the time series data have high accuracy, and the user experience is improved when surfing the internet. In addition, compared with other methods, determining whether the user has the abnormal behavior by the stationarity of the time series data is highly accurate and highly efficient.

S206, a relationship between the stationarity parameter and the preset value is determined. If the stationarity parameter is less than or equal to the preset value, the stationarity parameter indicates that the time series data are stable and the user is confirmed to have no abnormal behavior; otherwise, the user is confirmed to have the abnormal behavior.

Specifically, in practical applications, if the stationarity parameter is less than or equal to 0.01, the stationarity parameter indicates that the time series data are stationary time series data, and then the user is confirmed to have no abnormal behavior.

If the stationarity parameter is more than 0.01, the stationarity parameter indicates that the time series data are the non-stationary time series data, and the user is confirmed to have the abnormal behavior.

Optionally, after the step S206 of determining that the user has the abnormal behavior, the method also includes acquiring a network address of the login apparatus of the user, the process of which may be acquiring the network address of the login apparatus of the user from the login data of the user. In addition, the process may be implemented in other methods, and the present embodiment does not limit the specific method.

The process of determining whether the user corresponding to the network address and the user corresponding to the relevant network address of the network address have the abnormal behavior may be acquiring the network address of the user and a plurality of relevant network addresses of the network address.

The relevant network addresses include but are not limited to network addresses that belong to a same routing apparatus with the network address according to the abnormal behavior or network addresses within a preset regional range of a location of the network address according to the abnormal behavior.

The method of determining whether the user corresponding to the relevant network addresses of the network address has the abnormal behavior is the same as that described in Step S201 to Step S206, and is not be repeated here.

Because the abnormal behavior of multiple users in a certain range may occur at the same time, for example, multiple scalpers snapping tickets up or the like behaviors. Therefore, the abnormal behavior of multiple users can be found in time by determining whether the users corresponding to the network address and the users corresponding to the relevant network address of the network address have the abnormal behavior, and the accuracy and efficiency are high.

Exemplarily, in order to further illustrate the beneficial effects achieved by the embodiments of the present invention, it is assumed that the result of the unit root test on the pre-processed time series data is shown in FIG. 4. In the figure, the x-axis is time series of every 10 minutes, and the y-axis is a time series data and the time series data are the login frequency. By performing the method described in the embodiments of the present invention, it can be obtained that the stability parameter of the time series data is less than 0.01, and it is determined that the user has no abnormal behavior when the time-series data are stable.

The embodiment of the present invention provides a method for detecting the abnormal behavior of the user. Because the time series data more accurately describe a network behavior of the user, it is of high accuracy that determining whether the user has the abnormal behavior through the time series data, and the user experience is improved when surfing the internet. In addition, compared with other methods, determining whether the user has the abnormal behavior by the stationarity of the time series data is highly accurate and highly efficient. In addition, compared with other data, the processing procedure and the acquisition method of the number of the login frequency are relatively simple, therefore, determining whether the user has the abnormal behavior by the time series data including the login frequency can further improve the efficiency.

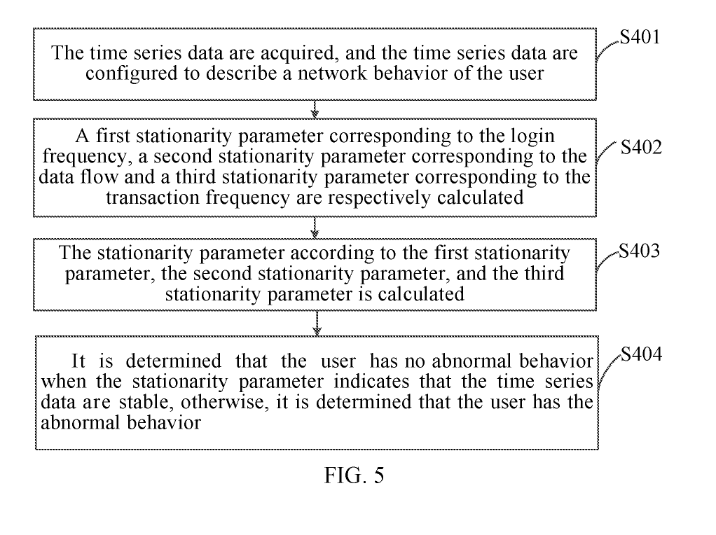

Another embodiment of the present invention provides a method for detecting the abnormal behavior of the user. In the embodiment of the present invention, the time series data include the login frequency, the data flow and the transaction frequency. As shown in FIG. 5, the method includes the following steps.

S401, the time series data are acquired, and the time series data are configured to describe a network behavior of the user.

Specifically, the time series data include the login frequency, the data flow and the transaction frequency, and the time series data are configured to describe the network behavior of the user.

The above time series data may be acquired by any one of the following operations. The time series data are periodically acquired and the process of which is the same as the process described in the step S201, and details are not described herein.

Or the time series data are acquired when the time series data satisfy the preset condition, the process of which is the same as the process described in Step S202, and details are not described herein.

In addition, in practical applications, the acquisition process of the login frequency, the data flow and the transaction frequency may be performed simultaneously, or may be performed separately and the present embodiment does not limit the specific acquiring order.

Before Step S402, the process of pre-processing the time series data and generating pre-processed time series data may also be performed, which is the same as the process described in the step S203, and details are not described herein.

S402, a first stationarity parameter corresponding to the login frequency, a second stationarity parameter corresponding to the data flow and a third stationarity parameter corresponding to the transaction frequency are respectively calculated.

Specifically, a unit root test is performed on the pre-processed time series data and obtaining the stationarity parameter included in the test result. The process of calculating the first stationarity parameter corresponding to the number of the login frequency is the same as the process described in Step S204 to Step S205, and details are not described herein.

Similarly, the process of calculating the second stationarity parameter corresponding to the data flow and the third stationarity parameter corresponding to the transactional number of times is the same as the process described in the Step S204 to Step S205, and details are not described herein again.

S403, the stationarity parameter according to the first stationarity parameter, the second stationarity parameter, and the third stationarity parameter is calculated.

Specifically, in practical applications, the stationarity parameter may be calculated by calculating the average value or the weighted average value of the first stationarity parameter, the second stationarity parameter, and the third stationarity parameter. Exemplarily, taking the weighted average value of the first stationarity parameter, the second stationarity parameter and the third stationarity parameter as an example, the step may be implemented by the following formula.

Stationarity parameter=(a*first stationarity parameter+b*second stationarity parameter+c*third stationarity parameter)/3;

In the above formula, the values of a, b and c may be set specific values according to the importance of the login frequency, the data flow and the transaction frequency in the actual application, and the present embodiment does not limit the specific setting method.

It should be noted that Step S402 to Step S403 are the implementation process of calculating the stationary parameter corresponding to the time series data. In addition to the method described in the above steps, other methods may implement the process, and the present embodiment does not limit the specific method.

Compared with determining whether the user has abnormal behavior by any one of the login frequency, the data flow and the transaction frequency, the occurrence of misjudgment when the network of the user suffer the problems such as a network disconnection is avoided by determining whether the user has the abnormal behavior by the login frequency, the data flow and the transaction frequency. Thereby, the accuracy of detecting of the abnormal behavior of the user is improved and the user experience is further improved.

S404, it is determined that the user has no abnormal behavior when the stationarity parameter indicates that the time series data are stable, otherwise, it is determined that the user has the abnormal behavior.

Specifically, the process is the same as the process described in Step S206, and details are not described herein.

The embodiment of the present invention provides the method for detecting the abnormal behavior of the user. Because the time series data more accurately describe a network behavior of the user, it is of high accuracy that determining whether the user has the abnormal behavior through the time series data, and the user experience when surfing the internet is improved. In addition, compared with other method, determining whether the user has the abnormal behavior by the stationarity of the time series data is highly accurate and highly efficient. In addition, compared with determining whether the user has the abnormal behavior by any one of the login frequency, the data flow and the transaction frequency, the occurrence of misjudgment when the network of the user suffer the problems such as a network disconnection is avoided by determining whether the user has the abnormal behavior by the login frequency, the data flow and the transaction frequency. Thereby, the accuracy of detecting of the abnormal behavior of the user is improved and the user experience is further improved.

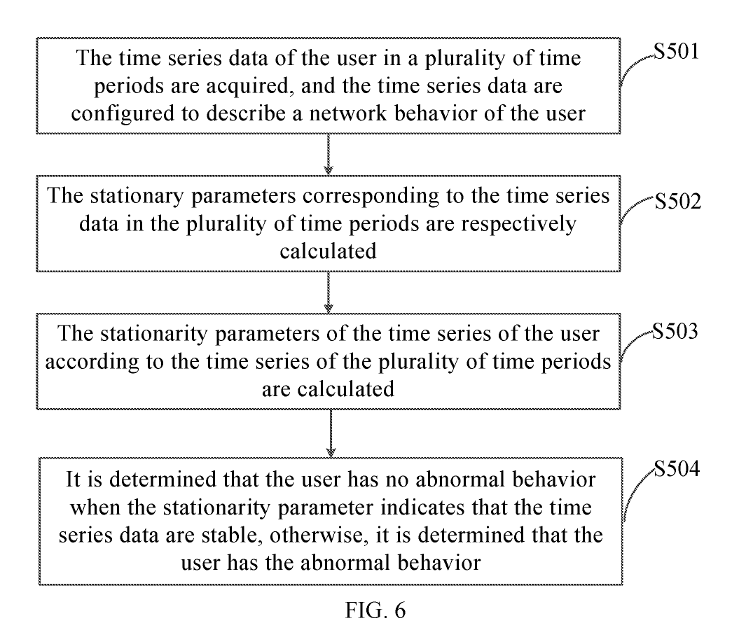

Another embodiment of the present invention provides a method for detecting the abnormal behavior of the user. In the embodiment of the present invention, the acquired time series data are the time series data of the user in a plurality of time periods, as shown in FIG. 6, the method includes the following steps.

S501, the time series data of the user in a plurality of time periods are acquired, and the time series data are configured to describe a network behavior of the user.

Specifically, the time series data in the plurality of time periods described above are acquired by any of the following operations. The plurality of the time series data are periodically acquired, and the method for acquiring any one of the plurality of the time series data are the same as the method for periodically acquiring the single time series data described in Step S201 and details are not described herein. Or, the plurality of time series data are acquired when the time series data satisfy the preset condition. The method for acquiring any one of the plurality of the time series data is the same as the method for periodically acquiring the single time series data described in the step S201 and details are not described herein.

Before Step 502, the process of pre-processing the time series data of the plurality of time periods and generating the plurality of pre-processed time series data may also be performed. The processes of pre-processing time series data of any one of the plurality of time periods and generating pre-processed time series data are the same as the process of pre-processing the time series data described in Step S203, and details are not described herein.

S502, the stationary parameters corresponding to the time series data in the plurality of time periods are respectively calculated.

Specifically, unit root tests are respectively performed on the pre-processed time series data. The process of performing the unit root test on any one of the plurality of the pre-processed time series data is the same as the process described in Step S204, and details are not described herein.

The process of separately acquiring the stationarity parameters included in the test results are the same as the process described in the step S205, and details are not described herein.

S503, the stationarity parameters of the time series of the user according to the time series of the plurality of time periods are calculated.

Specifically, in practical applications, the stationarity parameter may be calculated by an average value or a weighted average value of the stationarity parameters corresponded to the time series data of the plurality of time periods. Exemplarily, taking the weighted average value of the stationarity parameters corresponded to the time series data of n time periods as an example, the step may be implemented by the following formula.

Stationarity parameter=(a1*stationarity parameter one+a2*stationarity parameter two+ . . . +an*stationarity parameter n)/n.

In the above formula, the values of a1, a2 . . . an may be set specific values according to the transaction situation or the number of online users in each time period.

It should be noted that Step S502 to Step S503 are the implementation process of calculating the stationary parameter corresponding to the time series data. In addition to the method described in the above steps, the process may be implemented in other ways and the present embodiment does not limit the specific method.

By using the time series data of the plurality of time periods to determine whether the user has the abnormal behavior, the misjudgment of the normal operation of the user caused by the large number of online users and the special business (such as snapping up, etc.) can be avoided when the transaction volume or the number of the user increases in one period. Thereby, the accuracy of detection the abnormal behavior of the user is improved and the user experience is further improved.

S504, it is determined that the user has no abnormal behavior when the stationarity parameter indicates that the time series data are stable, otherwise, it is determined that the user has the abnormal behavior.

Specifically, the above process is the same as the process described in Step S206, and details are not described herein.

The embodiment of the present invention provides the method for detecting the abnormal behavior of the user. Since the time series data more accurately describe a network behavior of the user, it is of high accuracy that determining the user has the abnormal behavior through the time series data, thereby the user experience is improved when surfing the internet. In addition, compared with other method, determining whether the user has the abnormal behavior by the stationarity of the time series data is highly accurate and highly efficient. Moreover, by determining whether the user has the abnormal behavior by the time series data of the plurality of time periods, the misjudgment of the normal operation of the user because of the large number of online users and the special business (such as snapping up, etc.) can be avoided when the transaction volume or the number of users increases in one period. Thereby, the accuracy of detection the abnormal behavior of the user is improved and the user experience is further improved.

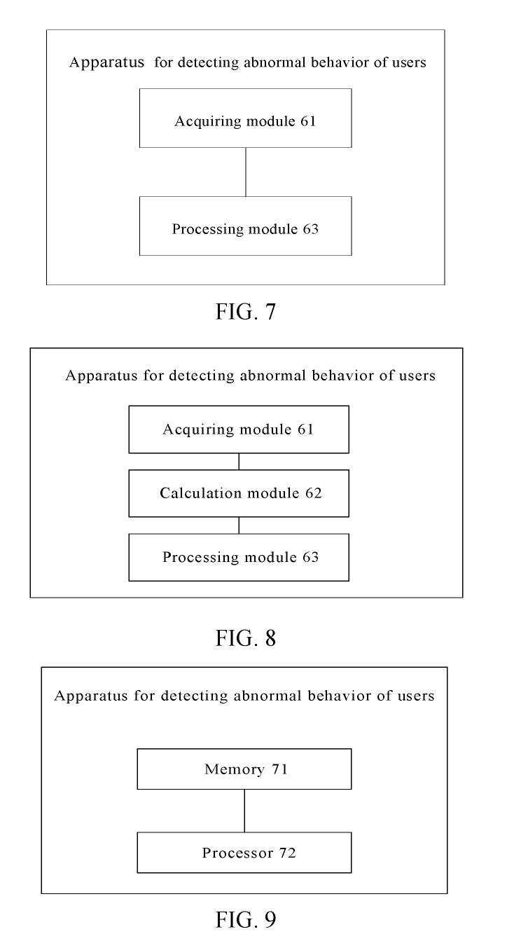

According to another aspect of the present invention, an embodiment of the present invention provides an apparatus 60 for detecting the abnormal behavior of the user. As shown in FIG. 7, the apparatus 60 includes an acquiring module 61 configured to acquire time series data which are determined according to an executive frequency of at least one network behavior in a plurality of preset time periods and a processing module 63 configured to determine that the user corresponding to the at least one network behavior has the abnormal behavior, when the acquired time series data are not stable.

It should be understood that each module or unit for detecting abnormal behavior of the user provided in the above embodiments corresponds to one step of the method for detecting abnormal behavior of the user described in the above embodiments. The operation and feature described in the above method are also applicable to the apparatus and the corresponding modules included herein, and the repeated content is not described herein again.

On the basis of the above embodiment, another embodiment of the present invention provides an apparatus for detecting the abnormal behavior of the user, as shown in FIG. 8, which includes an acquiring module 61 configured to acquire time series data which are configured to describe network behavior of the user, a calculating module 62 configured to calculate a stationarity parameter corresponding to the time series data, and a processing module 63 configured to determine that the user has no abnormal behavior when the stationarity parameter indicates that the time series data are the stable, otherwise determine that the user has the abnormal behavior.

Optionally, the acquiring module 61 is configured to perform any one of the following operations. The time series data are periodically acquired, or the time series data are acquired when the time series data satisfy a preset condition.

Optionally, the apparatus further includes a pre-processing module which is configured to pre-process the time series data and generate the pre-processed time series data.

Optionally, the calculating module 62 is specifically configured to perform a unit root test on the pre-processed time series data, and acquire the stationarity parameter included in the test result.

Optionally, the time series data include at least one of a login frequency, data flow and a transaction frequency. The calculating module 62 is further configured to calculate respectively a first stationarity parameter corresponding the login frequency, a second stationarity parameter corresponding to the data flow and a third stationarity parameter corresponding to the transaction frequency, and calculate a stationarity parameter according to the first stationarity parameter, the second stationarity parameter and the third stationarity parameter.

Optionally, the acquiring module 61 is further configured to acquire a network address of a login apparatus of the user; and the processing module 63 is further configured to determine whether the network address and the user associated with the network address have the abnormal behavior.

Optionally, the acquiring module 61 is configured to acquire time series data in a plurality of time periods. The calculating module 62 is configured to calculate the plurality of stationarity parameters corresponding to the plurality of time series data and calculate a final stationarity parameter according to the plurality of stationarity parameters. And the processing module 63 is configured to determine that the user has no abnormal behavior, when the stationarity parameter indicates that the time series data are the stable, otherwise determine that the user has the abnormal behavior.

The embodiment of the present invention provides an apparatus for detecting the abnormal behavior of the user. Since the time series data more accurately describe the network behavior of the user, it is of high accuracy that determining whether the user has the abnormal behavior through the time series data, thereby the user experience is improved when surfing the internet. In addition, compared with other methods, determining whether the user has the abnormal behavior by the stationarity of the time series data is highly accurate and highly efficient.

Another embodiment of the present invention provides an apparatus for detecting the abnormal behavior of the user. As shown in FIG. 9, the apparatus includes a memory 71 and a processor 72 connected to the memory 71, and the memory 71 is used for storing a set of program codes and the processor 72 calls the program codes stored in the memory 71 for performing any one of the above detection methods.

In a further embodiment, the operation may further include acquiring the time series data which are configured to describe the network behavior of the user, calculating the stationarity parameter corresponding to the time series data, and determining that the user has no abnormal behavior when the stationarity parameter indicates that the time series data are stable, otherwise, determining that the user has the abnormal behavior.

Optionally, the processor 72 calls the program codes stored in the memory 71 in order to perform any one of the following operations. The time series data are periodically acquired, or the time series data are acquired when the time series data satisfy the preset condition.

Optionally, the processor 72 calls the program codes stored in the memory 71 in order to perform the following operation. The time series data are pre-processed, and the pre-processed time series data are generated.

Optionally, the processor 72 calls the program codes stored in the memory 71 in order to perform the following operation. A unit root test is performed on the pre-processed time series data, and the stationarity parameter included in the test result is acquired.

Optionally, the time series data include at least one of a login frequency, data flow and a transaction frequency. The processor 72 calls the program codes stored in the memory 71 in order to perform the following operation. A first stationarity parameter corresponding the login frequency, a second stationarity parameter corresponding to the data flow and a third stationarity parameter corresponding to the transaction frequency are respectively calculated; and a stationarity parameter according to the first stationarity parameter, the second stationarity parameter and the third stationarity parameter is calculated.

Optionally, the processor 72 calls the program codes stored in the memory 71 in order to perform the following operation. The network address of the login apparatus of the user is acquired, and it is determined that whether the network address and the user associated with the network address have the abnormal behavior.

Optionally, the processor 72 calls the program codes stored in the memory 71 in order to perform the following operation. The time series data of the user in a plurality of time periods are acquired. A plurality of stationarity parameters corresponding to the plurality of time series data are calculated, and a final stationarity parameter according to the plurality of stationarity parameters is calculated. It is determined that the user has no abnormal behavior when the final stationarity parameter indicates that the time series data are stable, otherwise it is determined that the user has the abnormal behavior.

The embodiment of the present invention provides an apparatus for detecting the abnormal behavior of the user. Since the time series data more accurately describe the network behavior of the user, it is of high accuracy that determining whether the user has the abnormal behavior through the time series data, thereby the user experience is improved when surfing the internet. In addition, compared with other methods, determining whether the user has the abnormal behavior by the stationarity of the time series data is highly accurate and highly efficient.

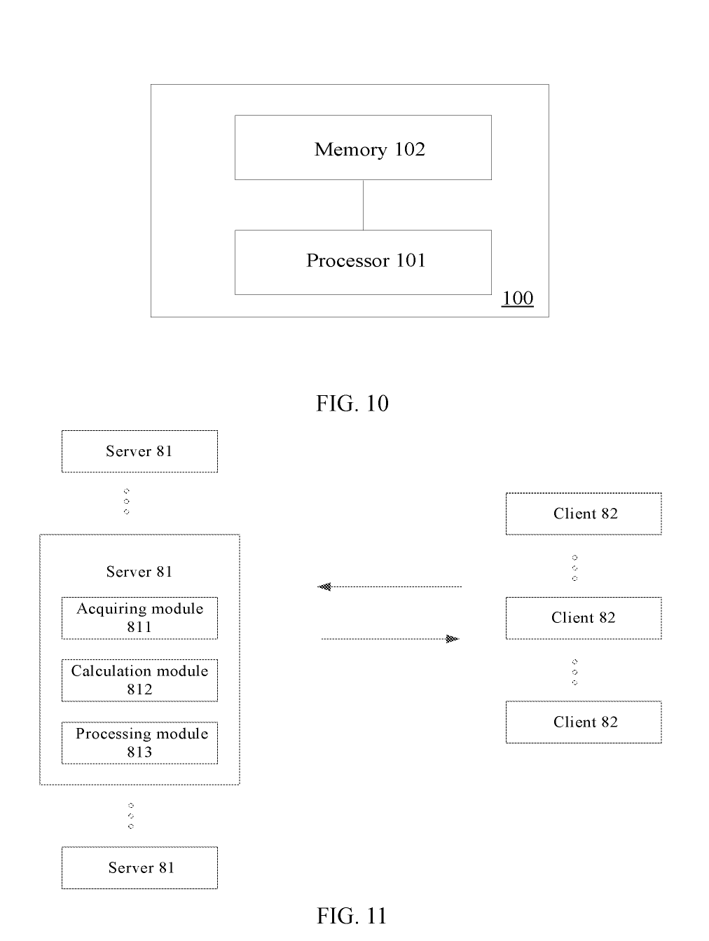

According to another aspect of the present invention, the present invention provides a system for detecting the abnormal behavior of the user. As shown in FIG. 10, the system includes a plurality of servers and a plurality of clients, and the plurality of the servers are communication connected with the plurality of the clients.

The clients are configured to implement at least one network behavior and generate a time series data, and the servers include any one of the detection apparatus described above.

The network behavior of the user is accurately described by the time series data, so the accuracy of determining whether the user has the abnormal behavior by the time series data is higher, thereby the user experience is improved when surfing the internet.

According to another aspect of the present invention, an embodiment of the present invention provides an apparatus for detecting the abnormal behavior of the user. As shown in FIG. 10, the device 100 includes a memory 102, a processor 101, and an instruction stored in the memory 102 and executed by the processor 101; when the instruction is executed by the processor 101, the processor 101 implements anyone of the methods for detecting the abnormal behavior of the user according to embodiments described above.

Another embodiment of the present invention provides a system for detecting the abnormal behavior of the user. As shown in FIG. 11, the system includes a plurality of servers 81 and a plurality of clients 82, the plurality of servers 81 are communication connected with the plurality of clients 82. The servers 81 include an acquiring module 811, configured to acquire the time series data which are configured to describe a network behavior of the user, a calculation module 812, configured to calculate a stationarity parameter corresponding to the time series data, and a processing module 813, configured to determine that the user has no abnormal behavior when the stationarity parameter indicates that the time series data are stable, otherwise determine that the user has the abnormal behavior.

The clients 82 are configured to implement the network behavior of the user and generate the time series data.

Optionally, the acquiring module 811 is configured to perform any one of the following operations. The time series data are periodically acquired, or the time series data are acquired when the time series data satisfy a preset condition.

Optionally, the apparatus further includes a pre-processing module configured to pre-process the time series data and generate the pre-processed time series data.

Optionally, the calculation module 812 is specifically configured to perform a unit root test on the pre-processed time series data and acquire the stationarity parameter included in the test result.

Optionally, the time series data include at least one of a login frequency, data flow and a transaction frequency. The calculation module 812 is further configured to calculate respectively a first stationarity parameter corresponding the login frequency, a second stationarity parameter corresponding to the data flow and a third stationarity parameter corresponding to the transaction frequency; and calculate a stationarity parameter according to the first stationarity parameter, the second stationarity parameter and the third stationarity parameter.

Optionally, the acquiring module 811 is further configured to acquire the network address of the login apparatus of the user. The processing module 812 is further configured to determine whether the network address and the user associated with the network address have the abnormal behavior.

Optionally, the acquiring module 811 is configured to acquire the time series data in a plurality of time periods. The calculation module 812 is configured to calculate a plurality of stationarity parameter corresponding to the plurality of the time series data and calculate a final stationarity parameter. The processing module 813 is configured to determine that the user has no abnormal behavior when the stationarity parameter indicates that the time series data are stable, otherwise determine that the user has the abnormal behavior.

The embodiment of the present invention provides a system for detecting abnormal behavior of the user. Since the time series data more accurately describe the network behavior of the user, it is of high accuracy that determining whether the user has the abnormal behavior through the time series data, thereby the user experience is improved when surfing the internet. In addition, compared with other methods, determining whether the user has the abnormal behavior by the stationarity of the time series data is highly accurate and highly efficient.

All of the above optional technical solutions may be combined arbitrarily to form an optional embodiment of the present invention, and details are not further described herein.

The process of the any one of previous methods may also be implemented as machine readable instructions that include programs performed by a processor. The programs may be materialized in software stored on a tangible computer readable medium such as CD-ROM, floppy disk, hard disk, digital versatile disk (DVD), Blu-ray disk or other forms of memory. Alternatively, some or all of the steps in the previous methods may be implemented by any combination of application specific integrated circuits (ASIC), programmable logic devices (PLD), field programmable logic devices (FPLD), discrete logic, hardware, firmware, etc. In addition, although the data processing method is described in a flowchart corresponding to any one of the foregoing methods, the steps in the previous methods may be modified, deleted, or merged.

As mentioned above, the process of any one of the previous methods may also be implemented by encoding instructions (such as computer readable instructions) which are stored on a tangible computer readable medium such as hard disk, flash memory, read-only memory (ROM), compact disk (CD), digital video disk (DVD), high speed buffer, random access memory (RAM), and/or any other storage mediums. The information on the storage medium may be stored for any periods (for example, for a long time, permanently, briefly, temporarily buffered, and/or cached information). As is used herein, the term tangible computer readable medium is expressly defined to include any type of computer readable stored signal. Additionally or alternatively, the example procedure of any one of the previous methods may be implemented by the encoding instructions (such as computer readable instructions) which is stored non-temporary computer readable media such as hard disk, flash memory, read-only memory, compact disk, digital video disk, high speed buffer, random access memory, and/or any other storage medium. The information on the storage medium may be stored for any periods (for example, for a long time, permanently, briefly, temporarily buffered, and/or cached information).

It should be noted that the apparatus provided by the above mentioned embodiment is only illustrated by the division of each functional module. In practical applications, the above function may be distributed by different functional modules to complete according to requirements. The internal structure of the apparatus is divided into different functional modules to perform all or part of the functions described above. In addition, the embodiments provided by the above embodiments are in the same concept, and the specific implementation process is described in details in the embodiments of the method, and details are not described herein.

Those skilled in the art can understand that all or part of the steps of implementing the above embodiments may be completed by hardware or the relevant hardware instructed by the program. The program may be stored in a computer readable storage medium, and the storage medium mentioned above may be a read only memory, a magnetic disk or an optical disk or the like.

The above embodiments are only preferable embodiments of the present invention, and are not intended to limit the protection scope of the present invention. Any modifications, equivalents substitutions, improvements, etc. made within the spirit and principles of the present invention should be embraced within the protection scope of the present invention.

What is claimed is:

1. A method for detecting abnormal behavior of an user, comprising:
acquiring time series data, wherein the time series data are configured to describe at least one network behavior; and
determining that the user corresponding to the at least one network behavior has an abnormal behavior, when the acquired time series data are not stable.

2. The method of claim 1, wherein the at least one network behavior comprises one or more of the followings: a login request, a data transmission request and a transaction request.

3. The method of claim 1, wherein the acquiring the time series data comprises: periodically acquiring the time series data, or acquiring the time series data when the time series data satisfy a preset condition.

4. The method of claim 3, wherein the time series data are determined according to an execution frequency of the at least one network behavior in a plurality of preset time periods, and the preset condition comprises: a sum of the execution frequency of the at least one network behavior corresponding to the time series data being more than a preset frequency within a set time.

5. The method of claim 1, wherein after the determining that the user corresponding to the at least one network behavior has an abnormal behavior, the method further comprises:
acquiring a network address of a login apparatus of the user that has the abnormal behavior; and
determining whether the user corresponding to the network address and the user corresponding to a relevant network address of the network address have the abnormal behavior.

6. The method of claim 5, wherein the relevant network address comprises: a network address that belongs to a same routing apparatus with the network address that initiates a current network behavior; or a network address within a preset regional range of a location of the network address that initiates the current network behavior.

7. The method of claim 1, further comprising:
performing a stationarity test on the time series data and calculating a stationarity parameter;
wherein the determining that the user corresponding to the at least one network behavior has the abnormal behavior, when the acquired time series data are not stable comprises:
determining that the time series data are not stable, when the stationarity parameter is more than a preset value.

8. The method of claim 7, wherein the time series data comprise at least one of a login frequency, data flow and a transaction frequency; wherein the calculating the stationarity parameter corresponding to the time series data comprises:
respectively calculating a first stationarity parameter corresponding the login frequency, a second stationarity parameter corresponding to the data flow and a third stationarity parameter corresponding to the transaction frequency; and
calculating the stationarity parameter according to the first stationarity parameter, the second stationarity parameter and the third stationarity parameter.

9. The method of claim 1, further comprising:
pre-processing the acquired time series data;
wherein the determining that the user corresponding to the at least one network behavior has an abnormal behavior when the acquired time series data are not stable comprises:
determining that the user corresponding to the at least one network behavior has the abnormal behavior when the pre-processed the time series data are not stable.

10. The method of claim 1, further comprising:
acquiring the time series data in a plurality of time periods; and
averaging the time series data of the plurality of time periods to obtain average time series data;
wherein the determining that the user corresponding to the at least one network behavior has an abnormal behavior when the acquired time series data are not stable comprises:
determining that the user corresponding to the at least one network behavior has the abnormal behavior when the average time series data are not stable.

11. An apparatus for detecting abnormal behavior of an user, comprising:
a processor; and
a memory, configured to store an instruction, wherein when the instruction is executed, the processor implements the following steps:
acquiring time series data, wherein the time series data are configured to describe at least one network behavior; and
determining that the user corresponding to the at least one network behavior has an abnormal behavior, when the acquired time series data are not stable.

12. The apparatus of claim 11, wherein the at least one network behavior comprises one or more of the following: a login request, a data transmission request and a transaction request.

13. The apparatus of claim 11, wherein when implementing the step of acquiring time series data, the processor specifically implements the following steps:
periodically acquiring the time series data, or acquiring the time series data when the time series data satisfy a preset condition.

14. The apparatus of claim 13, wherein the preset condition comprises a sum of the execution frequency of corresponding to the time series data being more than a preset frequency within a set time.

15. The apparatus of claim 11, wherein when implementing the step of acquiring time series data, the processor specifically implements the following steps:
acquiring the time series data corresponding to the current network behavior, when a relevant the network address of the network address initiates a current network behavior has the abnormal behavior.

16. The apparatus of claim 15, wherein the relevant network comprises a network address that belongs to a same routing apparatus with the network address that initiates the current network behavior or a network address within a preset regional range of a location of the network address that initiates the current network behavior.

17. The apparatus of claim 11, wherein the processor further implements the following steps:
performing a stationarity test on the time series data and calculating a stationarity parameter;
wherein determining that the time series data are being not stable, when the stationarity parameter is more than a preset value.

18. The apparatus of claim 11, wherein the processor further implements the following steps:
pre-processing the acquired time series data, wherein determining that the user corresponding to the at least one network behavior has the abnormal behavior when the pre-processed the time series data are not stable.

19. The apparatus of claim 11, wherein when implementing the step of determining that the user corresponding to the at least one network behavior has an abnormal behavior, the processor specifically implements the following steps:
acquiring the time series data in a plurality of time periods, averaging the time series data of the plurality of time periods to obtain average time series data and determining that the user corresponding to the at least one network behavior has the abnormal behavior when the average time series data are not stable.

20. A system for detecting abnormal behavior of an user, the system comprising a plurality of servers and a plurality of clients communicating with the plurality of servers, wherein the client is configured to implement the at least one network behavior and generate the time series data, and the server comprises the detecting apparatus according to claim 11.
